(19) United States
(12) Patent Application Publication
(10) Pub. No.: US 2026/0349456 A1
(43) Pub. Date: Nov. 5, 2026

(54) BACK PRESSURE REGULATOR

(71) Applicant: Equilibar, LLC, Fletcher, NC (US)

(72) Inventors: JEFFREY DEAN JENNINGS, Fletcher, NC (US); OMUNG CHHINA, Fletcher, NC (US); KEITH ALAN ROBERTS, Fletcher, NC (US); ZACHARY ALLAN COBB, Fletcher, NC (US); PAUL MARTIN KOWALL, III, Fletcher, NC (US); TONY BOYD TANG, Fletcher, NC (US)

(21) Appl. No.: 19/124,472

(22) PCT Filed: Jan. 8, 2024
(86) PCT No.: PCT/US24/10717

§ 371 Date: Apr. 25, 2025

Related U.S. Application Data
(60) Provisional application No. 63/423,923, filed on Nov. 9, 2022.

(51) Int. Cl. G05D 16/00; G05D 16/06

(52) U.S. Cl. CPC G05D 16/024; G05D 16/06

(57) ABSTRACT

A back pressure regulator includes: a body defining a process surface, and including: at least one inlet orifice; three or more outlet orifices, outboard of the inlet orifice; an inlet port communicating with the inlet orifice; and an outlet port communicating with the outlet orifices; a reference cap; and a diaphragm constrained between the body and the reference cap and arranged such that, in response to a process pressure being higher than a reference pressure, a fluid flow path will be open that extends from the inlet orifice to the outlet orifice, and in response to the reference pressure being higher than the process pressure, the flow path will be closed; wherein a sum total of a cross sectional area of the at least one inlet orifice is at least 10 times greater than a sum total of a cross sectional area of the three or more outlet orifices.

### BACKGROUND OF THE INVENTION

The present invention relates to pressure regulation, and more particularly to a diaphragm-type valve which controls a process pressure to match a reference pressure signal.

Dome loaded back pressure regulators (“BPR”) are commercially available that closely match a reference (or pilot) pressure to the inlet pressure. The primary benefits of these valves are sensitivity, resolution, and ability to operate in demanding chemical and biopharma applications across an exceptionally wide flow rate window.

This class of BPR is a direct diaphragm sealing, dome-loaded, multiple orifice valve. When the inlet pressure exceeds the pilot pressure on the top of the diaphragm, the diaphragm is moved out of communication with the outlet orifices, allowing flow through the outlet orifices while maintaining a relatively close balance between the inlet pressure and the pilot pressure.

Commercial direct diaphragm sealing BPRs for laboratory applications have very precise agreement between pilot and inlet pressure (this agreement may be referred to interchangeably as differential pressure and overpressure), such as 0.4 percent to 0.8 percent. However, these units are designed To achieve this agreement only at low flow rates and at low relative flow capacity (compared with maximum Cv), and achieve highest precision when used with high pressure gases. The limited inlet capacity of these valves makes them unsuitable to meet the demand for a high precision BPR that can perform through the broad flow ranges discussed in this patent.

Commercial BPRs designed to handle higher flow rates (for example, with flow coefficient (Cv) >0.1) typically have many outlet orifices and are designed to provide an economical compromise between the needs of precision and economy (i.e., minimization of diameter). These BPRs tend to have inlet pressures about 102 percent to 104 percent of pilot pressure (2 percent to 4 percent agreement) at low flows, with significantly increasing overpressure ratios at increasing flow rates.

There remains a need for a back pressure regulator that can hold inlet pressure and pilot pressure within close agreement across a wide range of flow rates, and at high maximum flow coefficients between 0.15 (such as ¼″ NPT pipe size) up through Cv max of 150 (such as 4″ pipe size).

### BRIEF SUMMARY OF THE INVENTION

According to one aspect of the technology described herein, a back pressure regulator includes: a body defining a process surface, and including: at least one inlet orifice communicating with the process surface; three or more outlet orifices communicating with the process surface, positioned outboard of the at least one inlet orifice; an inlet port disposed in fluid communication with the at least one inlet orifice and adapted to be coupled in fluid communication with a fluid at a process pressure; and an outlet port disposed in fluid communication with the outlet orifices; a reference cap including a reference surface and a reference port disposed in fluid communication with the reference surface, the reference port adapted to be coupled in fluid communication with a fluid at a predetermined reference pressure; and a diaphragm having opposed reference and process sides, the diaphragm constrained between the body and the reference cap and arranged such that, in response to the process pressure being higher than the reference pressure, a fluid flow path will be open that extends from the at least one inlet orifice to the outlet orifice, and in response to the reference pressure being higher than the process pressure, the flow path will be closed; wherein a sum total of a cross sectional area of the at least one inlet orifice is at least 10 times greater than a sum total of a cross sectional area of the three or more outlet orifices.

According to another aspect of the technology described herein, a back pressure regulator includes: a body defining a process surface, and including: at least one inlet orifice communicating with the process surface; three or more outlet orifices communicating with the process surface, positioned outboard of the at least one inlet orifice, wherein 95 percent or more of a sum total cross-sectional area of the outlet orifices is located within a diameter band of 60 percent to 82 percent of a free diameter of the diaphragm; an inlet port disposed in fluid communication with the at least one inlet orifice and adapted to be coupled in fluid communication with a fluid at a process pressure; and an outlet port disposed in fluid communication with the outlet orifices; a reference cap including a reference surface and a reference port disposed in fluid communication with the reference surface, the reference port adapted to be coupled in fluid communication with a fluid at a predetermined reference pressure; and a diaphragm having opposed reference and process sides, the diaphragm constrained between the body and the reference cap and arranged such that, in response to the process pressure being higher than the reference pressure, a fluid flow path will be open that extends from the at least one inlet orifice to the outlet orifice, and in response to the reference pressure being higher than the process pressure, the flow path will be closed.

### BRIEF DESCRIPTION OF THE DRAWINGS

The invention may be best understood by reference to the following description taken in conjunction with the accompanying drawing figures in which:

FIG. 1 is a top perspective view showing an exemplary embodiment of a back pressure regulator;

FIG. 2 is a bottom perspective view of the valve shown in FIG. 1;

FIG. 3 is a cross-sectional view of the valve shown in FIG. 1;

FIG. 4 is a top perspective view of a center section of the valve of FIG. 1;

FIG. 5 is a bottom perspective view of the center section shown in FIG. 6;

FIG. 6 is a top plan view of an alternative center section;

FIG. 7 is a top planned view of another alternative center section;

FIG. 8 is a schematic diagram of a piping system using a back pressure regulator;

FIG. 9 is a chart showing back pressure regulator performance; and

FIG. 10 is a chart showing back pressure regulator performance.

### DETAILED DESCRIPTION OF THE INVENTION

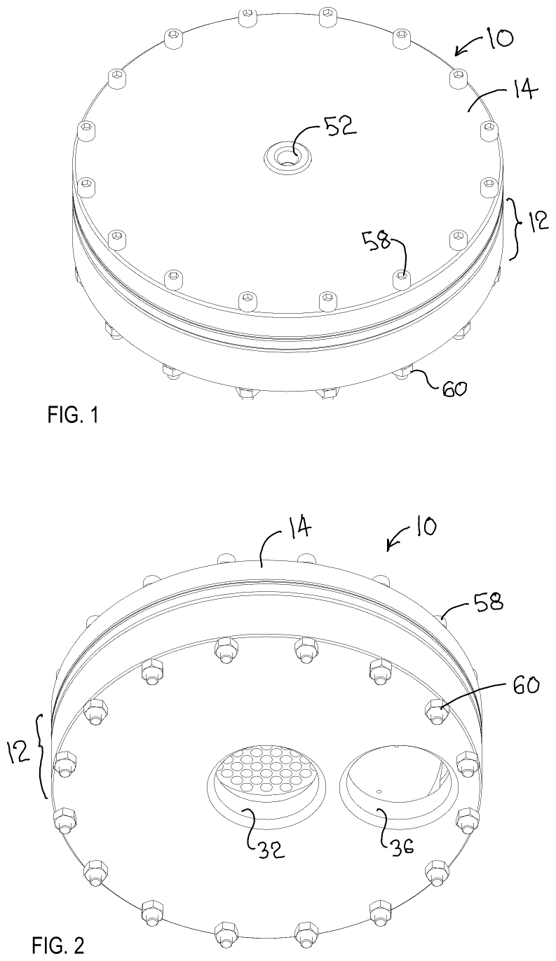

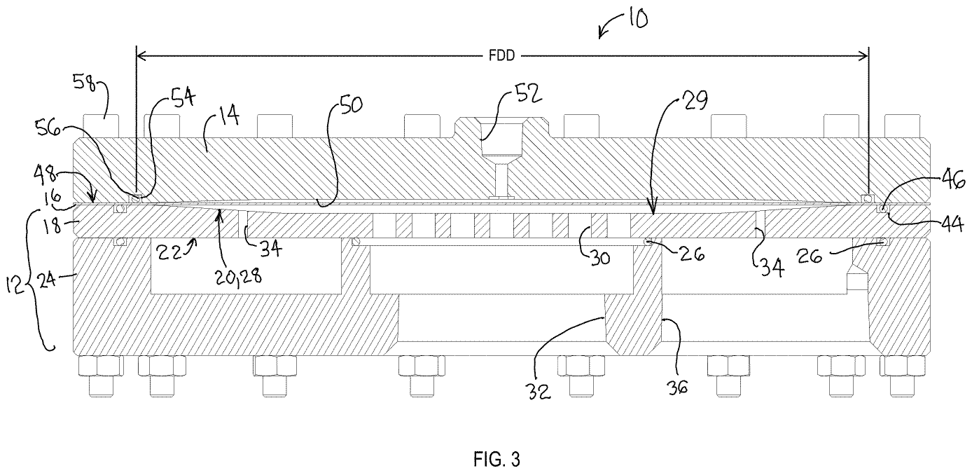

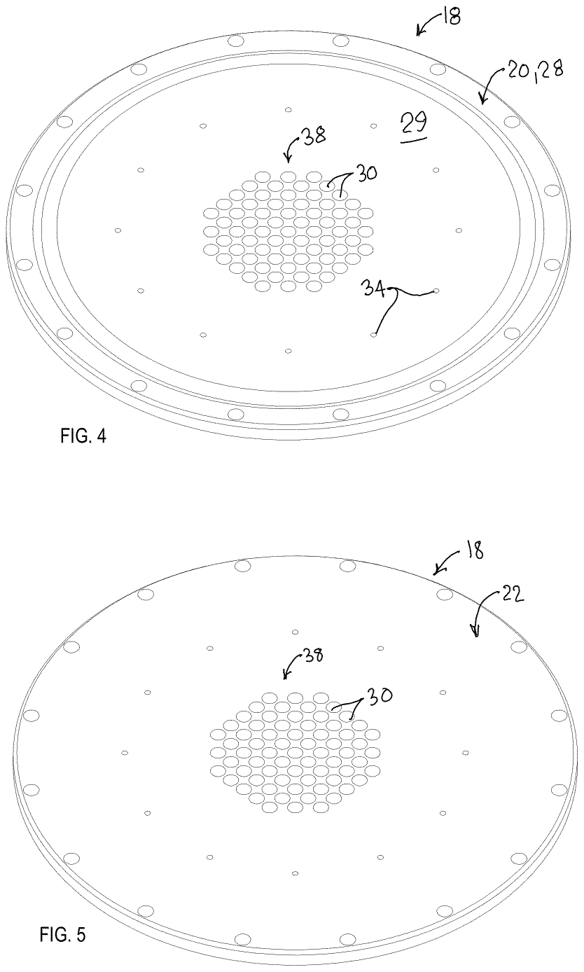

Referring to the drawings wherein identical reference numerals denote the same elements throughout the various views, FIGS. 1-5 depict an exemplary back pressure regulator 10 constructed according to an aspect of the present invention. The basic components of the back pressure regulator 10 are a body 12, a reference cap 14, and a diaphragm 16.

The body 12 may have various different configurations as dictated by cost, manufacturability, or other considerations. In the illustrated example, the body 12 is built from a disk-like center section 18 with opposed top and bottom faces 20, 22. The bottom face 22 abuts a bottom cap 24.

Optionally, seals 26 such as O-rings seal any gaps between the center section 18 and the bottom cap 24. Examples of suitable sealing materials include but are not limited to commercial elastomers or polymers, e.g., FKM, FFKM, nitrile, EPDM, or similar materials.

The body 12 and its constituent parts may be manufactured using various methods such as machining from a block of precursor material, additive manufacturing processes (e.g., “3-D printing”), or molding from a polymer suitable for the application requirements.

The material of the body 12 is selected to suit a particular application based on requirements such as temperature, pressure, chemical compatibility, etc. Non-limiting examples of suitable materials which are chemical-resistant include stainless steel (e.g. T316/T316L, AL6XN), nickel-based alloys such as HASTELLOY (e.g. HASTELLOY C276), PVC, brass, PEEK, PTFE, Olefins such as polyethylene, or polypropylene.

The upper face 20 of the body defines a process surface 28. The process surface 28 has a shallow recess 29 in the illustrated example, but different geometries may be used, for example, the process surface 28 may be planar or may include protrusions.

The process surface 28 may have a lower seal groove 44 formed therein. A resilient lower seal 46, for example an O-ring, is disposed in the lower seal groove 44. As an alternative, a crush seal may be formed by the diaphragm 16 between the body 12 and the reference cap 14, in which case the lower seal 46 or other separate seal could be eliminated.

At least one inlet orifice 30 communicates with the process surface 28. The function of the inlet orifice (or orifices) 30 is to bring the process fluid into the back pressure regulator 10. The inlet orifice (or orifices) 30 communicate with an inlet port 32 formed in the body 12. The inlet orifices 30 (if more than one is present) are grouped together forming a cluster 38.

A plurality of outlet orifices 34 communicate with the process surface 28. The function of the outlet orifices 34 is to vent process fluid from the back pressure regulator 10. The outlet orifices 34 communicate with an outlet port 36 formed in the body 12.

In the illustrated example, the cluster 38 of inlet orifices 30 is located in the center of the body 12, with the outlet orifices 34 located around the cluster 38. Stated another way, the outlet orifices 34 are positioned outboard of the inlet orifices 30. Stated another way, the outlet orifices 34 surround the inlet orifices 30.

The reference cap 14 is a generally rigid member having a reference surface 48 which is shaped to define an internal reference cavity 50. An integral reference port 52 is connected in fluid communication with the reference cavity 50. The reference surface 48 has an upper seal groove 54 formed therein. A resilient upper seal 56, for example an O-ring, is disposed in the upper seal groove 54. As an alternative, a crush seal may be formed by the diaphragm 16 between the body 12 and the reference cap 14, in which case the lower seal 46 or other separate seal could be eliminated.

Like the body 12, the material of the reference cap 14 is selected to suit a particular application based on requirements factors such as temperature, pressure, chemical compatibility, etc. Because the reference cap 14 is non-wetted by the fluid process, it may be constructed of strong but not chemically-resistant materials (such as carbon steel) as well as chemically resistant stainless steel or other suitable materials.

The diaphragm 16 has opposed sides referred to as reference and process sides, with the process side facing the body 12 and the reference side facing the reference cap 14. The outer perimeter of the diaphragm 16 is secured between the body 12 and the reference cap 14.

The diaphragm 16 may be constructed from a material which is chemically inert and/or chemically resistant. Nonlimiting examples of suitable diaphragm materials include: polyether ether ketone (PEEK), polytetrafluoroethylene (PTFE), glass-reinforced PTFE, polyphenylsulfone such as RADEL, polyimide, or stainless steel such as SAE 316, or a nickel-based alloy such as HASTELLOY.

Means are provided for joining the reference cap 14 to the body 12 and to hold pressure forces. In the illustrated example, an array of clamp bolts 58 pass through the reference cap 14, the center section 18, and the bottom cap 24, and are secured by clamp nuts 60. The diaphragm 16 is clamped between the reference surface 48 and the process surface 22.

The function of the back pressure regulator 10 may be enhanced by the inclusion of one or more geometric features, described below. Unless otherwise noted, any of the features may be used in conjunction with any of the other features. Unless otherwise noted, numerical ranges stated herein are intended to be inclusive of the endpoint values.

The process surface 28 is the support surface on the fluid wetted side of the direct sealing diaphragm 16, and that surface contains multiple inlet orifices 30 and multiple outlet orifices 34, which allow the fluid to enter and exit the space between the process surface 28 and the diaphragm 16.

In a key example, the cluster 38 of inlet orifices 30 are located in the center region of the process surface 28. In an alternate example, the inlet orifices 30 are located off-center. In either configuration, the outlet orifices 34 substantially surround the inlet orifice cluster 38.

One factor is the ratio of the sum total of the inlet orifices' cross sectional area to the sum total of the outlet orifices' cross-sectional area. In one example, this ratio may be at least 10. In another example, the ratio may be from 10 to 30. In another example, the ratio may be from 15 to 25.

Another factor is the ratio of the sum total of the outlet orifices' open cross sectional area to the total free diaphragm area, where the free diaphragm area is defined as the area inside the seal containment ring or other perimeter restraint, i.e. the area of the diaphragm 16 that is free to move. The Free Diaphragm Diameter, also referred to as “FDD” is that diameter which bounds the Free Diameter Area. In one example, this ratio may be less than 0.6 percent. In another example, this ratio may be less than 0.4 percent. In another example, this ratio may be from 0.5 percent to 3 percent. In another example, this ratio may be from 0.5 percent to 5 percent.

Another factor is the diaphragm movement gap, defined as the distance normal to the diaphragm plane in which the diaphragm 16 is free to move upwards and downwards, i.e., the total movement gap between the process surface 28 to the non-wetted upper surface of the reference cavity 50 over the region of outlet orifices 34. In one example, the diaphragm movement gap may be less than 300 percent of the diameter of the outlet orifice 34. In another example, the diaphragm movement gap may be less than 150 percent of the diameter of the outlet orifice 34. In another example, the diaphragm movement gap may be from 75 percent to 135 percent of the diameter of the outlet orifice 34. If there are multiple sized of outlet orifices 34, the diaphragm movement gap may be computed with respect to the largest one of the outlet orifices 34.

In one example, the individual outlet orifice diameter may be from 0.040 in. to 0.15 in. In one example, the individual outlet orifice diameter may be from 0.050 in. to 0.12 in. In one example, the individual outlet orifice diameter may be from 0.040 in. to 0.063 in., In one example, the individual outlet orifice diameter may be from 0.045 in. to 0.055 in.

In another consideration, the inlet flow coefficient (Cv) may be substantially larger than that of the outlet flow coefficient. In one example, the inlet Cv may be from 10 to 60 times greater than the outlet Cv. In one example, the inlet Cv may be from 10 to 40 times greater than the outlet Cv. In another example, the inlet Cv may be from 10 to 30 times greater than the outlet Cv. In another example, the inlet Cv may be from 15 to 25 times greater than the outlet Cv.

“Flow coefficient” is a term quantifying the volume flow rate of fluid at a stated specific gravity through a valve, to the pressure drop across the valve. The larger the flow coefficient at a given pressure drop, the less resistance to flow a device has.

“Inlet Cv” and “outlet Cv” are defined as follows, when the back pressure regulator 10 is unassembled and there is no diaphragm present:

Inlet Cv is defined as the Cv from the inlet port 32 to the inlet orifices 30.

Outlet Cv is defined as the Cv from the outlet port 36 to the outlet orifices 34.

Another consideration is the thickness of the diaphragm 16. In one example, the diaphragm 16 may have a thickness of 0.004 in. to 0.030 in. In another example, the diaphragm 16 may have a thickness of 0.004 in. to 0.015 in. In another example, the diaphragm 16 may have a thickness of 0.004 in. to 0.010 in. In another example, the diaphragm 16 may have a thickness of 0.010 in. to 0.025 in.

Another consideration is the number of inlet orifices 30. In one example, the inlet orifice cluster 38 includes 5 or more inlet orifices 30. In one example, the inlet orifice cluster 38 includes 10 or more inlet orifices 30. In another example, the inlet orifice cluster 38 includes 20 to 40 inlet orifices 30.

Another factor is the number of outlet orifices 34. In one example, the number of outlet orifices 34 may be between 3 and 100 inclusive. In one example, the number of outlet orifices 34 may be between 3 and 24 inclusive. In another example, the number of outlet orifices 34 may be between 3 and 16 inclusive. In another example, the number of outlet orifices 34 may be between 3 and 8 inclusive. In another example, the number of outlet orifices 34 may be between 4 and 6 inclusive.

Another factor is the area of the inlet orifice cluster 38. In one example, the inlet orifice cluster 38 may be contained within a circle whose area consumes from 10 percent to 30 percent of the free diaphragm area. In one example, the inlet orifice cluster 38 may be contained within a circle whose area consumes from 10 percent to 20 percent of the free diaphragm area. In another example, the inlet orifice cluster 38 may be contained within a circle whose area consumes from 12 percent to 17 percent of the free diaphragm area.

In another factor, the ratio of sum total outlet orifice cross sectional area to the cross sectional area of the inside diameter of the fluid entry conduit to the back pressure regulator 10 may be less than 16 percent, with a preferred ratio from 6 percent to 12 percent.

In one example, the recess 29 of the process surface 29 may be recessed a distance from 0.5 percent to 1.5 percent of the free diameter of the diaphragm 16.

In another factor, the sum total of the inlet orifice cross sectional area may be from 75 percent to 160 percent of the cross sectional area of the conduit internal diameter (as appropriate for the rated pressure of the back pressure regulator 10). In another example, the sum total of the inlet orifice cross sectional area may be from 100 percent to 160 percent of the cross sectional area of the conduit internal diameter Another factor is the ratio of the outlet orifice diameter to the free diaphragm diameter of the diaphragm 16. It is noted that the terms free diameter of the diaphragm and free diaphragm diameter are used interchangeably herein. In one example, this ratio may be in the range of 2 percent to 3 percent. In another example, this ratio may be in the range of 0.08 percent to 3 percent. In another example, this ratio may be in the range of 1 percent to 2.5 percent. In another example, this ratio may be in the range of 1.3 percent to 2.7 percent.

Another factor is the location of the outlet orifices 34. The location of the outlet orifices 34 can be described in terms of a “diameter band” i.e., a band bounded by two concentric circles superimposed on the process surface 28, each sharing a common center with the center of the diaphragm 16, in which a preponderance of the area of the outlet orifices 34 lies.

As used herein, the term “preponderance” refers to the primary functional portion of the outlet orifice area, such as 95 percent or more of the outlet orifice cross-sectional area. This excludes the effect of small nominal or non-functional outlet orifices.

Prior art multiple orifice back pressure regulators have been designed according to the principles of maximizing the extent of the outlet orifice matrix and spreading the outlet orifices as far apart as possible.

Contrary to prior art teachings, the inventors have discovered that higher precision may be obtained by exposing a much larger area (near the center) of the diaphragm 16 only to inlet pressure without the presence of outlet orifices 34.

In some examples, this may be implemented by clustering the preponderance of outlet orifices 34 in a diameter band surrounding approximately 70 percent of the free diaphragm diameter. This exposes approximately half of the diaphragm area to the inlet pressure, providing greater lifting leverage to offset the suction forces provided by the lower pressure of the outlet orifice 34.

This factor can provide for improved precision for back pressure regulators, both those optimized for maximum precision (outlet/inlet capacity ratios >10) and those optimized for standard precision industrial applications (those with outlet/inlet capacity ratios <10.

In one example, a preponderance of the outlet orifice area may be located within a diameter band from 60 percent to 100 percent of the free diaphragm diameter.

In another example, a preponderance of the outlet orifice area may be located within a diameter band from 60 percent to 82 percent of the free diaphragm diameter.

In another example, a preponderance of the outlet orifice area may be located within a diameter band from 65 percent to 82 percent of the free diaphragm diameter.

In one example, a preponderance of the outlet orifice area may be located within a diameter band from 69 percent to 82 percent of the free diaphragm diameter.

In another example, a preponderance of the outlet orifice area may be located within a diameter band from 68 percent to 80 percent of the free diaphragm diameter.

Within these diameter bands, the outlet orifices 34 may be arranged in one or more concentric rings, or may be arranged in another pattern. The size of the outlet orifices 34 may be uniform or variable.

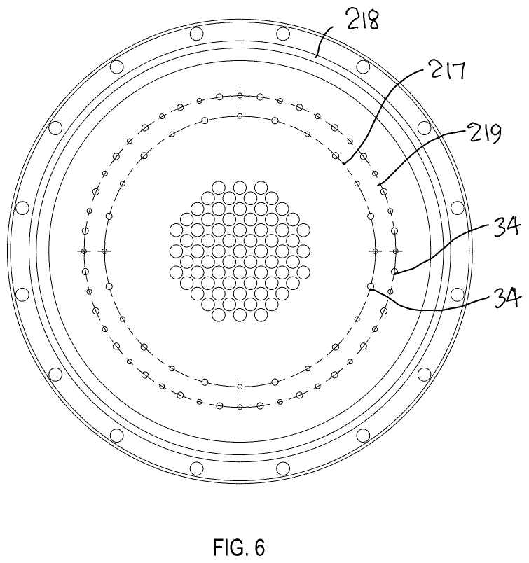

FIG. 6 shows an example of a center section 218. In this example, there are 36 outlet orifices 34 arranged in a first ring 217 at a diameter approximately 69 percent of the free diaphragm diameter, and 36 outlet orifices 34 arranged in a second ring 219 at a diameter approximately 80 percent of the free diaphragm diameter. In each ring 217, 219, there are 18 outlet orifices 34 of 0.096 in. diameter alternating with 18 outlet orifices 34 of 0.125 in. diameter.

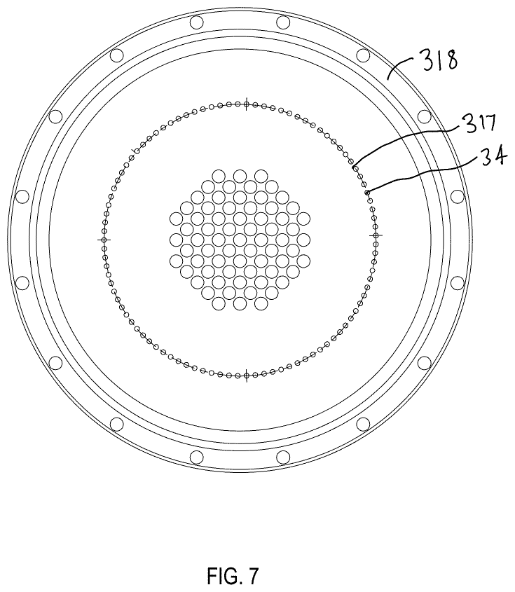

FIG. 7 shows an example of a center section 318. In this example, there are 97 outlet orifices 34 of 0.096 in. diameter, arranged in a ring 317 at a diameter approximately 70 percent of the free diaphragm diameter.

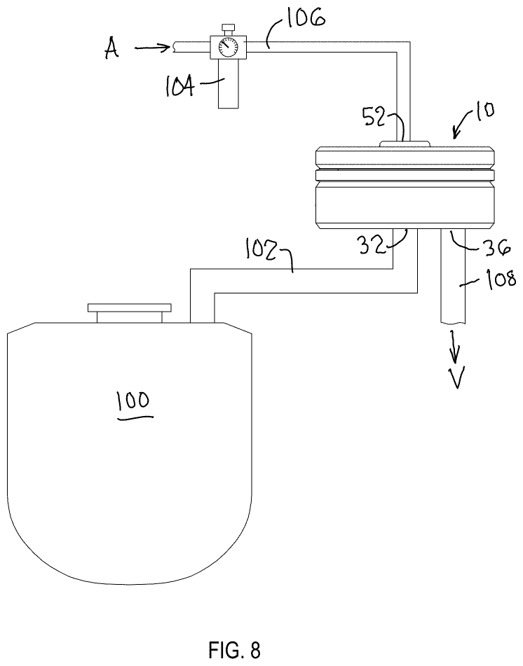

In operation, the inlet port 32 may be connected to a process pressure stream in a known manner, the reference port 52 may be connected to a reference pressure, and the outlet port 36 may be vented appropriately. For example, as shown in FIG. 8, the inlet port 32 may be connected to a process reactor 100 of a known type by a process line 102. The reference port 52 may be connected to a known type of device for generating a reference pressure, such as a pneumatic pressure regulator 104, by a line 106, which may be in turn connected to a reference pressure source such as compressed instrument air or a gas cylinder “A”. The outlet port 36 may be vented to atmosphere “V” by a simple vent line 108. During normal balanced or modulating mode the diaphragm 16 is drawn into a sealing relationship with the outlet orifices 34 due to the pressure differential between the vent pressure and reference (pilot) pressure. When the process pressure exceeds the reference pressure the diaphragm 16 is persuaded away from the outlet orifices 34 thereby allowing venting.

### EXAMPLE 1

A prototype of a back pressure regulator was tested, having the following characteristics:

The free diaphragm diameter is 1.88 in.

There are 4 outlet orifices 34 in the range of 0.048-0.053 in. diameter (nominal 0.050 in.) The outlet orifices 34 surround the inlet cluster 90 degrees apart, with their centers on a base circle diameter (BCD) that is 1.2 in.

There are 31 inlet orifices of 0.079 in. diameter clustered within a circle of 0.62 in. diameter.

Conduit is ¼ in. NPT Schedule 40.

Diaphragm of PEEK of 0.005 in. thickness.

FKM sealing O-rings.

Total Cv=approximately 0.22

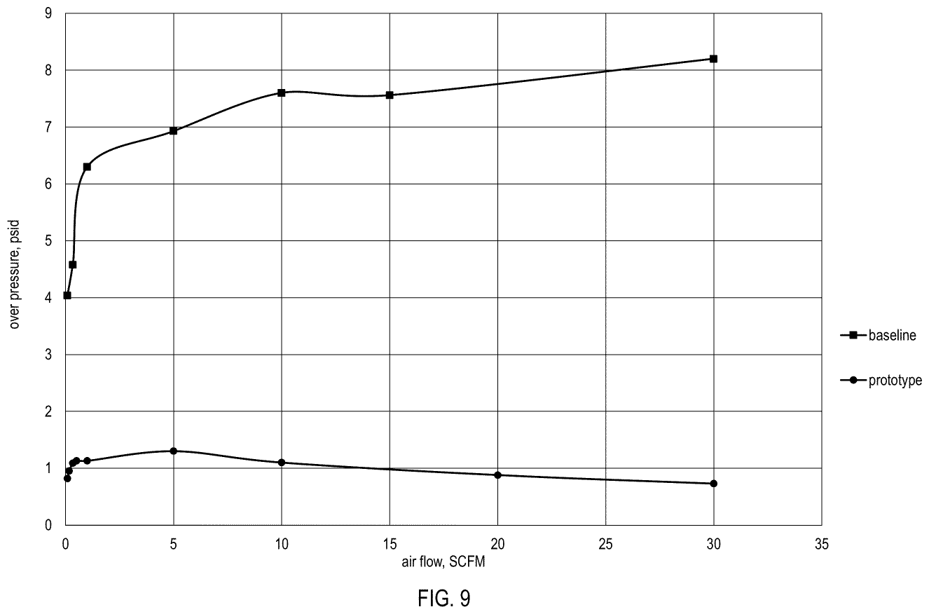

The prototype back pressure regulator was tested at flow rates of 0.06 to 30 SCFM air (360:1 ratio), at 220 psig. As seen in FIG. 9, it maintained an overpressure ratio (overpressure divided by total dP) of approximately 0.6 percent or better through this flow range.

### EXAMPLE 2

A prototype of a back pressure regulator was tested, having the following characteristics:

The free diaphragm diameter is 7.6 in.

There are 72 outlet orifices 34 total. The outlet orifices 34 surround the inlet cluster. 36 of them have their centers on a base circle diameter (BCD) that is 5.30 in. 36 of them have their centers on a base circle diameter (BCD) that is 6.1 in. In the outer ring, 24 have a nominal diameter of 0.096 in. and 24 have a nominal diameter that is 0.125 in. In the inner ring, 12 have a nominal diameter of 0.096 in. and 12 have a nominal diameter of 0.125 in.

There are 69 inlet orifices of 0.25 in. diameter clustered within a circle of 2.875 in. diameter.

Conduit is 2 in. NPT Schedule 40.

Diaphragm of PEEK of 0.02 in. thickness.

FKM sealing O-rings.

Total Cv=approximately 15

This prototype has a much higher Cv and can be characterized as an “industrial” regulator, in that its Cv is typical for commercial valves in that approximate size category.

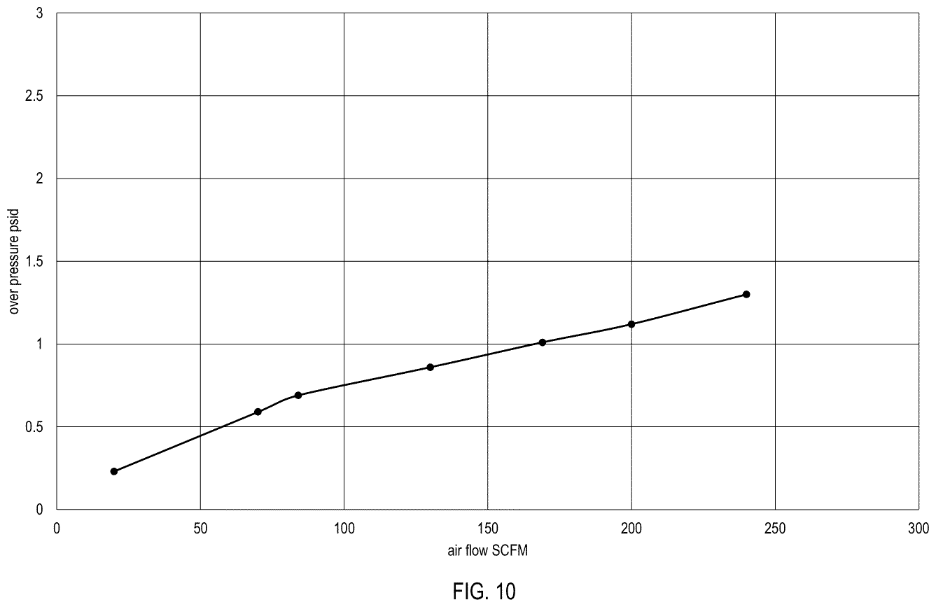

The prototype back pressure regulator was tested at flow rates of 19.9 to 240 SCFM air (12:1 ratio), at 60 psig. As seen in FIG. 10, it maintained a very low overpressure ratio of approximately 0.4 percent at the lower flow range, approximately 1.3 percent at the mid-flow range, and an overpressure ratio (overpressure divided by total dP) of approximately 2.5 percent or better through this flow range. This represents excellent performance for this size of valve.

Other tests and computations indicate that a back pressure regulator constructed as described according to the various descriptions herein can have even better performance. For example, a back pressure regulator may be able to hold inlet pressure and pilot pressure within 0.5 percent agreement across a wide range of flow rates, for example across 100:1 flow rate ranges, and with maximum flow coefficients (Cv) between 0.15 (such as ¼″ NPT pipe size) up through Cv max of 150 (such as 4″ pipe size).

The foregoing has described a back pressure regulator. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A back pressure regulator, comprising:
a body defining a process surface, and including:
at least one inlet orifice communicating with the process surface;
three or more outlet orifices communicating with the process surface, positioned outboard of the at least one inlet orifice;
an inlet port disposed in fluid communication with the at least one inlet orifice and adapted to be coupled in fluid communication with a fluid at a process pressure; and
an outlet port disposed in fluid communication with the outlet orifices;
a reference cap including a reference surface and a reference port disposed in fluid communication with the reference surface, the reference port adapted to be coupled in fluid communication with a fluid at a predetermined reference pressure; and
a diaphragm having opposed reference and process sides, the diaphragm constrained between the body and the reference cap and arranged such that, in response to the process pressure being higher than the reference pressure, a fluid flow path will be open that extends from the at least one inlet orifice to the outlet orifice, and in response to the reference pressure being higher than the process pressure, the flow path will be closed;
wherein a sum total of a cross sectional area of the at least one inlet orifice is at least 10 times greater than a sum total of a cross sectional area of the three or more outlet orifices.

2. The back pressure regulator of claim 1, wherein a sum total open area of the outlet orifices occupies less than 0.6 percent of a total free area of the diaphragm.

3. The back pressure regulator of claim 1, wherein a sum total open area of the outlet orifices occupies less than 0.4 percent of a total free area of the diaphragm.

4. The back pressure regulator of claim 1, wherein a diaphragm movement gap is 300 percent or less of a diameter of a largest one of the outlet orifices.

5. The back pressure regulator of claim 1, wherein an inlet flow coefficient of the back pressure regulator is at least 10 times greater than an outlet flow coefficient of the back pressure regulator.

6. The back pressure regulator of claim 1, wherein 95 percent or more of a sum total cross-sectional area of the outlet orifices is located within a diameter band of 60 percent to 100 percent of a free diameter of the diaphragm.

7. The back pressure regulator of claim 1, wherein 95 percent or more of a sum total cross-sectional area of the outlet orifices is located within a diameter band of 60 percent to 83 percent of a free diameter of the diaphragm.

8. The back pressure regulator of claim 6, wherein the outlet orifices are disposed in two or more rings within the diameter band.

9. The back pressure regulator of claim 1, wherein:
the process surface includes a central portion that is recessed relative to an outer perimeter of the process surface; and
the central portion is recessed a distance from 0.5 percent to 1.5 percent of a free diameter of the diaphragm.

10. The back pressure regulator of claim 1, wherein a ratio of sum total outlet orifice cross sectional area to a cross sectional area of the inlet port is less than 16 percent.

11. The back pressure regulator of claim 1, wherein at least 5 of the inlet orifices are disposed in the process surface and are arranged in a cluster.

12. A back pressure regulator, comprising:
a body defining a process surface, and including:
at least one inlet orifice communicating with the process surface;
three or more outlet orifices communicating with the process surface, positioned outboard of the at least one inlet orifice, wherein 95 percent or more of a sum total cross-sectional area of the outlet orifices is located within a diameter band of 60 percent to 82 percent of a free diameter of the diaphragm;
an inlet port disposed in fluid communication with the at least one inlet orifice and adapted to be coupled in fluid communication with a fluid at a process pressure; and
an outlet port disposed in fluid communication with the outlet orifices;
a reference cap including a reference surface and a reference port disposed in fluid communication with the reference surface, the reference port adapted to be coupled in fluid communication with a fluid at a predetermined reference pressure; and
a diaphragm having opposed reference and process sides, the diaphragm constrained between the body and the reference cap and arranged such that, in response to the process pressure being higher than the reference pressure, a fluid flow path will be open that extends from the at least one inlet orifice to the outlet orifice, and in response to the reference pressure being higher than the process pressure, the flow path will be closed.

13. The back pressure regulator of claim 12, wherein a sum total open area of the outlet orifices occupies 0.5 percent to 4 percent of a total free area of the diaphragm.

14. The back pressure regulator of claim 12, wherein a diaphragm movement gap is 300 percent or less than a diameter of a largest one of the outlet orifices.

15. The back pressure regulator of claim 12, wherein 95 percent or more of a sum total cross-sectional area of the outlet orifices are located within a diameter band of 69 percent to 82 percent of a free diameter of the diaphragm.

16. The back pressure regulator of claim 12, wherein the outlet orifices are disposed in two or more rings within the diameter band.

17. The back pressure regulator of claim 12, wherein 10 or more outlet orifices are located within the diameter band.

18. The back pressure regulator of claim 12, wherein:
the process surface includes a central portion that is recessed relative to an outer perimeter of the process surface; and
the central portion is recessed a distance from 0.5 percent to 1.5 percent of a free diameter of the diaphragm.

19. The back pressure regulator of claim 12 wherein at least 5 of the inlet orifices are disposed in the process surface and are arranged in a cluster.
